(19) United States
(12) Patent Application Publication
(10) Pub. No.: US 2008/0114651 A1
(43) Pub. Date: May 15, 2008

(54) OMAHA - USER PRICE INCENTIVE MODEL

(75) Inventors: Kamal Jain, Bellevue, WA (US); Zachary Abraham Apter, Seattle, WA (US); Jody D. Biggs, Redmond, WA (US); Brian Burdick, Bellevue, WA (US); Nishant V. Dani, Redmond, WA (US); Gary W. Flake, Bellevue, WA (US); Marcel Gavriliu, Issahquah, WA (US); Randall F. Kern, Seattle, WA (US); David Lawrence Kiker, Redmond, WA (US); Arun K. Sacheti, Sammamish, WA (US); Brian James Utter, Seattle, WA (US); Polina Veksler, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/768,855

(22) Filed: Jun. 26, 2007

Related U.S. Application Data
(63) Continuation-in-part of application No. 11/625,069, filed on Jan. 19, 2007.
Application No. 11/625,069 is a continuation-in-part of application No. 11/419,896, filed on May 23, 2006.
(60) Provisional application No. 60/764,618, filed on Feb. 2, 2006.

(51) Int. Cl. G06Q 30/00; G06Q 10/00

(52) U.S. Cl. 705/14

(57) ABSTRACT

The claimed subject invention presents a system and method to compensate a user of a service platform in return for information regarding the user's intent. The compensation comprises rewards points and direct payments, which can be used to claim rewards online and offline. The compensation is securely maintained in compensation accounts. The user can benefit from third-party content and services through partnerships with the service platform. The intent-compensation proposition of the service platform creates a price incentive to use the service platform over its competitors.

### CROSS-REFERENCE TO RELATED APPLICATION

This application is a continuation-in-part of U.S. patent application Ser. No. 11/625,069 entitled ALLOCATING REBATE POINTS, filed on Jan. 19, 2007, which is a continuation-in-part of co-pending U.S. patent application Ser. No. 11/419,896, filed May 23, 2006, entitled “AD PUBLISHER PERFORMANCE AND MITIGATION OF CLICK-FRAUD”, which claims the benefit of U.S. Provisional Application Ser. No. 60/764,618, filed Feb. 2, 2006, entitled “A COMPETITIVE PERSPECTIVE ON AD-AUCTION.” This application is also related to co-pending U.S. patent application Ser. Nos. 11/419,881, entitled “EMPLOYING CUSTOMER POINTS TO CONFIRM TRANSACTIONS”, 11/419,802, entitled “MERCHANT RANKINGS IN AD REFERRALS”, 11/419,859, entitled “AD TARGETING AND/OR PRICING BASED ON CUSTOMER BEHAVIOR”, and 11/419,865 entitled “SEARCH ENGINE SEGMENTATION”, all of which were filed on May 23, 2006. The entireties of these applications are incorporated herein by reference.

### TECHNICAL FIELD

The claimed subject matter relates to systems and methods to directly compensate a user of a service platform in exchange for conveying intent of the user regarding use of the service platform.

### BACKGROUND

Typically, in conventional user-service provider paradigm(s), a user selects a service or goods provider based on an expectation that the provider would satisfy the user's needs through relevant and competent service. Once a selection is made, the user conveys intent for a desired service or product, and receives from the provider a corresponding good or service. In this paradigm, service providers compete for user intent by offering quality service while campaigning for brand recognition, awareness and service/product differentiation.

While this paradigm may work well in industries where service is largely commoditized and providers aggressively strive to provide top quality service offering multiple choices to the user, in a defacto monopoly environment the user is obligated in practice to provide its intent for a service product without much choice.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

System(s) and method(s) as described herein provide for compensating a user of a service platform directly in return for knowledge of user intent. Such direct compensation scheme can drive a paradigm shift in the way services are provided. The intent-compensation proposition of the service platform creates a price incentive that differentiates the service platform from its competitors.

Compensation in connection with the service platform includes rewards points, or direct payments that can be used to claim rewards online and offline. The reward incentives are established by the service platform and a user of the service platform can register to receive rewards to claim specific incentives. In addition, the user can be compensated with generic points that allow the user to claim reward incentives of different types and scope. Such generic type of compensation has the advantage of having access to incentives categories that were not available at the time the user was compensated. The reward points can be perishable or perennial (e.g., depending on the user the points are awarded to and incentives the user intends to claim with them). It should be appreciated that users can also benefit from third-party content and services through partnerships established by the service platform for such purpose. Furthermore, through an intent-compensation proposition cycle, the service platform collects valuable intelligence on the user, such as personal and socioeconomic information. Such information can be employed in a closed-loop manner with the system to increase the value proposition and implement targeting advertisement and compensation campaigns.

It should be appreciated that the intent-compensation proposition brings at least three prominent advantages to the service platform: (i) Gain in user or market share, as users migrate from service platforms that do not offer compensation to the service platform that compensates its users; (ii) user retention, which can be attained from customization of the reward incentives and balance perishable and perennial points; and (iii) disintermediation of online retailers, which takes place through offering incentives directly from producers.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and novel features of the claimed subject matter will become apparent from the following detailed description of the claimed subject matter when considered in conjunction with the drawings.

### BRIEF DESCRIPTION OF DRAWINGS

FIG. 1 is a block diagram of a computer system that compensates a user of a service platform in return for the user's intent.

FIG. 2 is a block diagram of a computer system that manages a user's compensation and employs it to claim rewards.

FIG. 3 is a block diagram of a computer system in which a service platform retrieves user intelligence from a rewards component, and sells the user intelligence to an advertiser.

FIG. 4 is a diagram of an exemplary rewards store in which incentives are categorized.

FIG. 5A is a block diagram of a computer system in which a service platform partners with third-party providers.

FIG. 5B is a block diagram of a computer system that identifies a set of content providers based on user intelligence.

FIG. 6 is a block diagram of a computer system allows users to exchange compensation points.

FIG. 7 is a flowchart of a computer-implemented method for a service platform to compensate a user in return for the user's intent.

FIG. 8 is a flowchart of a computer-implemented method to manage a user's compensation.

FIG. 9 is a flowchart of a computer-implemented method to reward a user.

FIG. 10 is a flowchart of a computer-implemented method to alert a user of existing rewards.

FIG. 11 is a flowchart of a computer-implemented method to enhance user experience and retention.

FIG. 12 is a flowchart of a computer-implemented method to transfer compensation points among users.

FIGS. 13 and 14 illustrate computing environments for carrying out various aspects described herein.

### DETAILED DESCRIPTION OF INVENTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Further, the terms “component,” “system,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the term “service” can refer to executing a software, such as using a toolbar or web-based email engine; retrieving information (e.g., status of a pending patent application, a proposal submission, immigration process, or package delivery); purchasing goods; making a payment (e.g. mortgage, rent, student loan, credit card, car, phone, utilities, late fees); taking a class at an online school; making an appointment with an offline provider (e.g., dentist, medical doctor, lawyer, hairdresser, mechanic); or registering for an online or offline conference. It should be appreciated that this listing of services is provided as an illustration.

The term “intelligence” has two meanings: (i) it refers to information that characterizes history or behavior of a person or an entity, and to records of commercial and non-commercial activities involving a product or service, or a combination thereof, of the person or entity; and (ii) it refers to the ability to reason or draw conclusions about, e.g., infer, the current or future state of a system or behavior of a user based on existing information about the system or user. Artificial intelligence (AI) can be employed to identify a specific context or action, or generate a probability distribution of specific states of a system or behavior of a user without human intervention. Artificial intelligence relies on applying advanced mathematical algorithms—e.g., decision trees, neural networks, regression analysis, cluster analysis, genetic algorithm, and reinforced learning-to a set of available data (information) on the system or user.

As described in greater detail below, a unique commerce model and service platform are described that facilitate optimizing consumer/provider interactions. In particular, mechanisms are described that provide for quickly receiving, soliciting, or gleaning user intent with respect to desired services or goods. Knowledge of such intent provides for service/goods providers to optimize utilization of resources (e.g., bandwidth, advertising, marketing efforts, communications, funds, . . . ) in connection with offering, selling, and provisioning of services/goods. To encourage users to share intent, mechanisms are provided to reward or compensation users for conveying intent. Accordingly, market efficiencies are achieved through service platforms described herein that facilitate utilization of resources and converging on connecting desired customers with desired service/goods providers. Moreover, employment of Internet-based communication schemes provides for dynamic allocation/modification of rewards as a function of supply/demand and achieving and staying at or close to market equilibrium points.

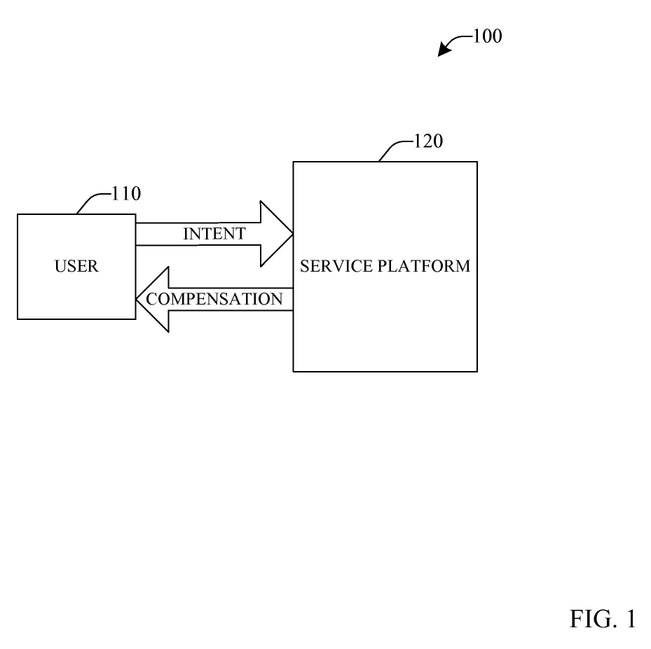

FIG. 1 depicts a computer system 100 in which a service platform 120 compensates a user 110 in return for knowledge of the user's intent. The user's intent reveals underlying purpose of accessing the service platform 120 and constitutes a key to receiving service from it. The user discloses intent based on an expectation that the service platform 120 would be relevant to the user's needs. The service platform component 120 is neither limited to a specific industry nor a specific service. Desirable characteristics of a service are that the service is primarily consumed through the Internet and used regularly (e.g., on a daily basis). The user's intent and the service provided by the service platform 120 are interdependent. In one embodiment, the service platform may be for example an online portal of a technical journal, where a user looking to retrieve a specific article provides a citation to the article (intent) and the publisher responds by delivering the article to the user. In another embodiment, the service platform may be a translation interface that translates text entered in a translation interface by the user. In yet another embodiment, the service platform can be a search engine, the search query is the key to receiving a list of search results. Moreover, user intent can be related to searching for a provider or particular goods or services, and a plurality of providers may compete for knowledge of such intent (e.g., by offering rewards/incentives) in order to be presented to the user in a favorable forum/light that will facilitate a commercial transaction transpiring between the user and provider.

By compensating the user in return for conveying his/her intent, the service platform 120 creates a monetary differential in favor of the user, e.g., a user price incentive, and distinguishes itself from competitors. Such compensation affords the service platform at least the following prominent advantages. (i) Gain in user (market) share—users switch from service platforms that do not offer such compensation. This transition is based on a long-term behavior change of the user based on a continued compensation program, at an adequate compensation level, facilitated by the service platform. (ii) User retention—users that are compensated for their intent remain loyal to the service platform that provides such compensation. As an example, airlines, which offer an offline service, have pioneered the exploitation of the loyalty-compensation scheme through frequent-flyer programs. In another example, the segment of users that employ searches as the primary tool in their online purchases are the ones that benefit the most in such a compensation-based search platform; thus, such users are expected to be the most loyal to the service platform. However, user retention is dynamic and depends strongly on competitor response. Namely, users migrate among service platforms seeking the most advantageous compensation scheme. Therefore, to attain sustained user retention, continued differentiation is required from the service platform. For this reason, a direct compensation program provided by a service platform can drive a paradigm shift in the way services are provided. (iii) Disintermediation of online retailers—by providing compensation through an online service platform, producers can directly compensate a user, thus making an intermediary retailer unnecessary.

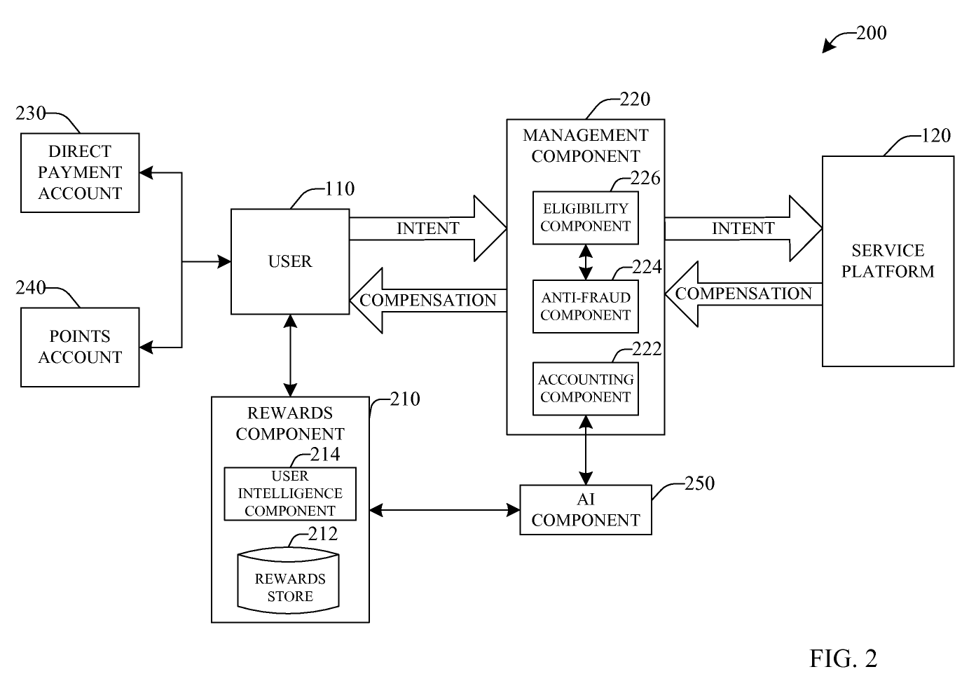

FIG. 2 illustrates a computer system 200 that manages a user's compensation and reward claims. The system comprises a management component 220 and a rewards component 210. It should be appreciated that although these components are illustrated separately, they can be merged into a single component that stands alone in the system or resides in the service platform component 120.

The management component 220 typically serves as a bridge between the user and service platforms. For example, the management component 120 can be effected by a third party service (e.g., Search Engine), or it can reside at the client end, or at the service provider end (e.g., as part of the service platform). Nevertheless, the management component 220 provides for managing dissemination and utilization of user intent as well as corresponding rewards/incentives. Moreover, the management component 220 can serve as a broker on behalf of the user where user intent is brokered to a plurality of service providers, and the management component selects a service provider that it deems best suited to satisfy the user's service/goods needs as well as offering a suitable level of rewards in exchange for the user intent information.

Unlike conventional couponing and rebate schemes, the management component determines or infers user intent dynamically (for example via Internet or wireless communications—e.g., search engines and cellular telephones are suitable platforms to deploy various embodiments described herein) and utilizes the user intent to facilitate joining the user with a suitable service provider in connection with maximizing utility to the user, or the service provider. Moreover, the management component 220 provides users with bargaining power (via solicitation of user intent information) that conventionally was often provided for free by the user. As a result, users increase buying power or wealth through leveraging off the value of their respective intent information, and a filtering process is achieved where unmotivated service/goods providers are not exposed to the users thereby mitigating spam-like solicitations. It is to be appreciated that the management component can optionally perform a utility-based analysis where the value of service/goods by particular providers are weighted with rewards/incentives offered by the service/goods providers. Accordingly, a high-value service provider may not have to offer as great of a set of rewards as a lower quality service provider in order to be exposed to the user since the net utility to the user may be greater with the package provided by the high quality service provider notwithstanding a lesser level of rewards being offered.

Likewise, the management component 220 can also facilitate optimizing resource allocation and revenue generation for service/goods providers by differentiating among users and the respective value of particular users to the providers. For example, some users will have a higher probability of engaging in a commercial transaction than others, some users will likely spend more money than others, some users may be less overhead (e.g., require less hand-holding and attention) than others in order to commit to a commercial transaction, etc. Accordingly, the management component 220 can facilitate vetting users to the providers based on various metrics and policies so that the providers can allocate energies, resources, and rewards in a manner that increases return on investment.

User intent can be obtained in a variety of manners such as for example, explicit expression of user intent, implicit expression, determined or inferred user intent. Moreover, a variety of instruments or mechanisms can be employed to obtain user intent (e.g., portals, pop-up windows, queries, statements, utterances, inferences, extrinsic evidence, historical data, machine learning systems, etc.). Veracity of the user intent as well as confidence measures associated therewith can also be calculated or factored in connection with allocation of rewards/incentives.

Once compensation is ready to be awarded to a user 110, the management component 220 checks, via the eligibility component 226, whether the user is eligible to receive the compensation. In an embodiment, the eligibility component can check configuration of a user's machine, e.g., software installed to access the service platform 120, is compatible with such service platform. In addition, the eligibility component can check that usage of the service platform 120 vs. a competitor is above a predefined threshold determined by the service platform. Moreover, eligibility can be based for example on various metrics (e.g., age, sex, demographics, profiles, historical buying behavior, income level, occupation, reliability, etc.) that facilitate distinguishing desirable candidates from less desirable ones (e.g., spammers, children, individuals with bad credit . . . ). It is to be appreciated that rewards/incentives can likewise be dynamically tailored as a function of eligibility. For example, repeat high value customers may receive greater rewards than prospective new customers that have low probability of repeat business.

An antifraud component 224 monitors that the user is not compensated fraudulently. In an embodiment, the antifraud component 224 can actively mitigate attempts at fraudulent compensation by limiting value and selection (e.g., type and scope) of the rewards available to a user. For example, the level of compensation can be useful for at most N≦10 songs of a given music genre within a month, where such music genre and time period are determined by the service platform 120. As a result, a fraudster can only obtain a small number of songs, even when emulating an unlimited number of eligible users accessing the service platform 120. In another aspect of active protection, the antifraud component may prevent hackers from assailing the compensation accounts (230 and 240, FIG. 2) of legitimate users, which have monetary value in the intent-compensation proposition of the service platform, by encrypting the contents of the users' compensation accounts. Widespread techniques for encryption of online content and banking information can be used to secure the compensation accounts within the subject embodiment.

In another embodiment, the antifraud component 224 can prevent fraud reactively. Namely, in one aspect, the antifraud component can disqualify (i) compensation of an eligible user in response to a configuration change prior to eligible access to the service platform 120, (ii) a compensation level above a compensation cap determined by the service platform 120, or (iii) compensation that has been generated in bursts. In another aspect, the antifraud component could also employ software to monitor computer-scripted (bot) submissions of intent to the service platform.

Once eligibility and legitimacy of the compensation transaction is verified, in accordance with a particular embodiment, the user receives (i) a token that confirms user eligibility and legitimacy, and captures a combination of user intelligence and service requested, and (ii) either a direct payment in the user's direct payment account 230 (e.g., direct deposit to the user's checking or savings account) or points deposited in a rewards points account 240, or a combination thereof. The accounting component in the management component 220 updates the user's accounts. Transfer of compensation and update can take place on a per-eligible-transaction basis or at time intervals (e.g., weekly, monthly, quarterly) specified by the service platform 120 or the user 110. In case the management component 220 lumps direct payments at predefined time intervals, the accounting component 222 can maintain a ledger balance until the date in which actual monies are transferred to the user's direct payment account. The level of compensation is determined by the service platform and is at least proportional to the user usage of the service and the economic value of the user to the service platform.

The user 110 claims rewards based on available points through a rewards component 210. Such points can be used to redeem or claim one or more incentives that reside in a rewards store 212. Using points has prominent advantages. (a) Points overcome the inconveniences and costs of payments with monetary instruments (e.g., credit or debit card). The user does not have to provide information referent to the points when claiming an incentive, as would be the case when using monetary instruments; and no transaction fees are charged for use of points, such is not generally the case with monetary instruments.

Note that points can be used for incentives of small monetary value, e.g., a song; for such micro-payments, even small transaction fees are inefficient or infeasible. The user can download points to media and use them offline at content providers (CPs) affiliated, or that have partnered, with the service platform. In an embodiment, an affiliated CP can provide the user with custom-made media that is readable at the CP's offline stores. At the time of an offline transaction with the affiliated CP, the points are converted to monies according to a conversion factor established by the CP or the service platform or a combination thereof. As an example, a CP could be a producer of canned soda, a user downloads (encrypted) points in a key fob provided by the CP and uses the points to buy sodas at the self-serve kiosks of the CP. In another example, a user downloads into a portable memory component an encrypted, password protected and voice signed points file in a format suitable to be accessed by a specific CP, at the time of using the points offline in the specific CP store the user is prompted to introduce the password and verify the voice signature.

It should be appreciated that the service platform can sponsor the custom-made media and verification systems necessary to employ point offline. This can enhance brand recognition for the service platform, and facilitate user gain and retention. The conversion factor or exchange rate of points to monies can reflect the cost to the service platform of partnering with the CP, as well as the economical value of the user to the service platform; a user that consistently uses the service platform may have a higher conversion factor than a user that seldom uses the service platform. In a related aspect, the conversion factor may automatically change as a function of time for the same user, depending on user intelligence. It should be appreciated that other forms of media to download points, and other parameters, like economic value to the CP, to determine conversion factors can be used.

(b) Points can be generic or specific. At the time of compensation (system 200, FIG. 2), the user can be prompted to select whether the points are to be made generic or specific to certain type of incentive. Generic points have the advantage of being transferable among online and offline incentives—the latter accomplished via downloading to CP-specific media, as discussed above. Such feature allows a user to use points to claim new incentives that were not available at the time of compensation. In an embodiment, a service platform can place a premium on such versatility and award less reward points to eligible user-service platform interaction. Additionally, the user need not register with any incentives or CPs affiliated with the service platform. In contrast, specific points can be used for specific incentives and CPs, and, more importantly, for a user to be awarded specific points may require the user to register a priori to a specific set of incentives. On the other hand, a benefit of such registration to the service platform is that user intelligence is collected at the time the user registers. Such benefit can be further compensated with an initial lump sum of specific points. As an example, the lump sum of specific points can correspond to a variety of incentives and enough to claim premium content and services for a period of two or three months. In this time interval, the service platform can further collect intelligence on the user, such as the number of points the user is awarded, the number of incentives the user claims, the type of services the user use.

(c) Points can be perishable or perennial. Generic or specific points may be perishable at a specific time interval determined by the service platform. By having points with a expiration date, a user is forced to regularly use the points, which can be employed to collect intelligence on the user, and to facilitate retaining the user by having the user access the service platform to accrue new points. Points for low-cost incentives to the service platform, of limited scope, or for a user who seldom interacts with the service platform can be made perennial. Depending on affiliated content providers, points that are downloaded for use offline can be made perishable or perennial.

(d) Points can be used to boost user migration in specific segments. Points can be employed as a bonus to users that refer other users to the service platform. This is a common practice in rental apartment properties in which residents that currently live in a property are paid a predetermined amount of money for each new resident that is referred to the property and rents a unit. Similar strategies are employed by commodity service providers (e.g., cable companies). A referral program can lead to new users in a specific market segment that is likely compatible with that of the current, targeted users. Such is a consequence of the likelihood that users will refer people they know and have similar interests and other commonalities, like same socioeconomic and education profile. Therefore, the service platform can target a referral program to a specific segment of users (e.g., those with certain point balances, incentives claimed, ages and gender, and levels of education) through bonus lump sums of generic points that can be converted to specific points by the new user. The latter forces a new user to register for specific incentives, which results in new user intelligence collected by the service platform. It should be appreciated that any segmentation scheme can be used to target the referral program, and any such scheme is within the scope of the claimed subject matter.

(e) Points can be embedded with security features. Points can be assigned a token by the service platform that determines whether the points are specific or generic, and perishable or perennial. Tokens can be encrypted at the time of issuance by the service platform and decrypted at the time the points are redeemed. Only a user-token point-token pair allows points to be redeemed. Such a pair also binds the original legitimacy, user token to the value transferred in points by the service platform. For perishable and specific points, tokens contain an expiration date and an identifier for the specific incentive that the point applies to. In case of perennial and generic points the token is logic.

In computer system 200, an optional learning and reasoning system, referred to as artificial intelligence (AI) component 250 automatically identifies incentives in the reward store that can be of interest to the user, and alerts the user accordingly. The identification is based on user intelligence and incentives that are present in the rewards store 212. The user need not be registered to the incentives identified by the AI component. Based on accounting information of generic points, the AI component can suggest registering for specific incentives, as the user has sufficient (or close to sufficient) generic points that can be converted to specific points for the identified specific incentive. Note that each time an incentive suggested to the user by the AI component is accepted by the user, by either claiming the incentive or registering to accumulate compensation toward a specific incentive, the AI component learns about the user. When the user rejects a suggested incentive, the AI component also learns about the user. In another embodiment, the AI component can behave as a retention agent. As such, the AI component 250 assesses user intelligence and identifies desirable incentives that are below the number of points necessary to be claimed by the user. Then, the AI component informs the service platform of the points a user needs to claim a desirable incentive and suggest the service platform to award the user such points on a promotional basis for retention purposes. Such actions of the AI component can mitigate the effects of competitor response to the intent-compensation proposition of the service platform.

The AI component 250 can be employed in connection with making determinations or inferences regarding optimization decisions and the like. The AI component 250 can employ a probabilistic-based or statistical-based approach, for example, in connection with making determinations or inferences. The inferences can be based in part upon explicit training of classifier(s) (not shown) before employing the system 100, or implicit training based at least upon a user's or provider's previous actions, commands, instructions, and the like during use of the system. Data or policies used in optimizations can be collected from specific users or services/goods providers or from a community of users and providers.

The AI component 250 can employ one of numerous methodologies for learning from data and then drawing inferences from the models so constructed (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein.

Methods also include methods for capture of logical relationships such as theorem provers or more heuristic rule-based expert systems. Inferences derived from such learned or manually constructed models can be employed in optimization techniques, such as linear and non-linear programming, that seek to maximize some objective function. For example, maximizing the overall efficiency of determining or inferring user intent, identifying prospective and relevant services/goods providers, dynamically calculating, or conveying rewards/incentives as well as associated bi-directional filtering to optimize data consumption, resource utilization, optimizing return on investment (ROI), and the like.

The optimization policies can take into consideration inferences about user intent, goals, uncertainty, sporadic behavior, point of sale, inventory, time to delivery, quality, ratings, rankings, reputation, authenticity, reliability, and other factors that are considered in connection with commercial transactions, for example.

The AI component 250, can take into consideration historical data, and data about the current context (users, or providers). Policies can be employed that consider including consideration of the cost of making an incorrect determination or inference versus benefit of making a correct determination or inference. Accordingly, an expected-utility-based analysis can be used to provide inputs or hints to other components or for taking automated action directly. Ranking and confidence measures can be calculated and employed in connection with such analysis.

For example, the cost of making an incorrect decision regarding offering rewards to a particular set of prospective users given cost of doing so, available provider resources and monies versus expected ROI can be factored into decisions as part of the optimization process.

Policies can be employed that optimize reward/incentive utilization as well as cost thereof. In view of the foregoing example, it will be appreciated that optimization is dynamic and policies selected and implemented will vary as a function of the numerous parameters (e.g., supply/demand, user state, user goals, user preferences, costs, efficiency, available time, schedules, environment, inventory, workflow, advertising or rewards budget, price points, equilibrium points, market saturation levels, expected future demand, backlogs, trends, fads, dumping strategies, competitor analysis, user and provider tolerance levels, risk analysis, . . . ); and thus the AI component 150 is adaptive.

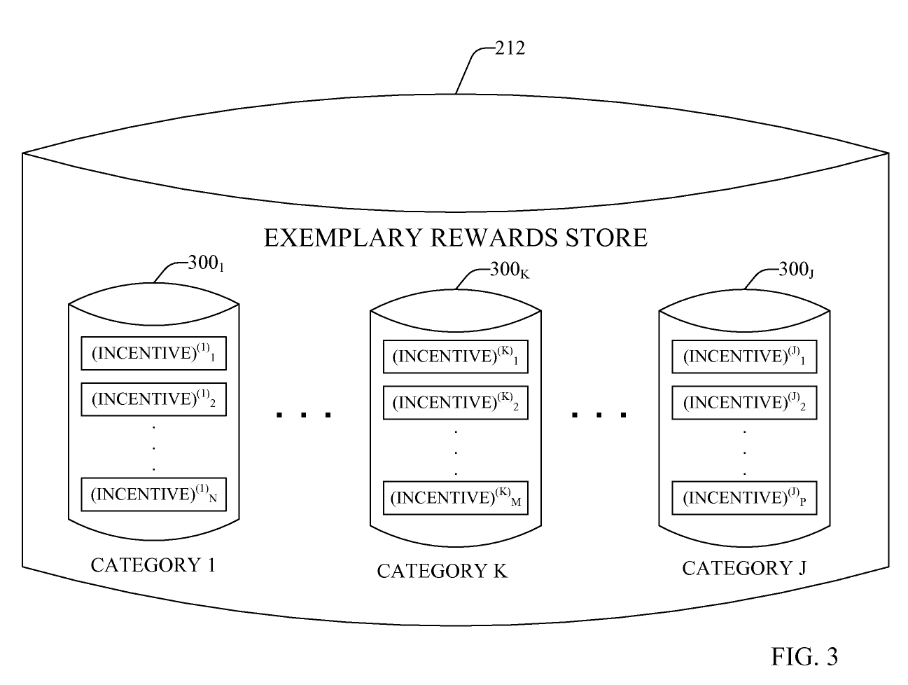

An exemplary rewards store is shown in FIG. 3. The rewards store 212 contains a plurality of incentives separated in categories 300₁-300ⱼ. Note that the reward store can be distributed among the service platform, or third-party content providers (see below). Each category comprises a set of incentives that present certain commonalities. For example, category 1 may contain incentives related to computer utility software; category K may contain incentives related to computer games; and category J may contain incentives related to a specific genre of music, movies or literature. Knowing which type of incentives a user claims provides the service platform with valuable user intelligence. Such user intelligence is an asset that allows conducting efficient targeting of advertising campaigns as well as matching an advertiser with a user. For example, a user may claim rewards from a category M (1≦M≦J) that relates to academic or scholastic content, then the user can be presented with advertisements for student loans or student credit cards, or other financial services, as well as advertisement from technical journals or publishers.

According to an aspect of the present invention, when claiming rewards (FIG. 2), the user intelligence component 214 gathers intelligence about the user. This intelligence can be limited, like IP address of the user's machine originating the reward claim, or extensive such as the user personal and socioeconomic data. The latter user intelligence can be gathered at the time the user subscribes to a specific incentive type in the rewards store. It should be appreciated that user intelligence can also comprise historical data-services used, frequency of using services, points accumulated in a given period of time, incentives claims, etc.

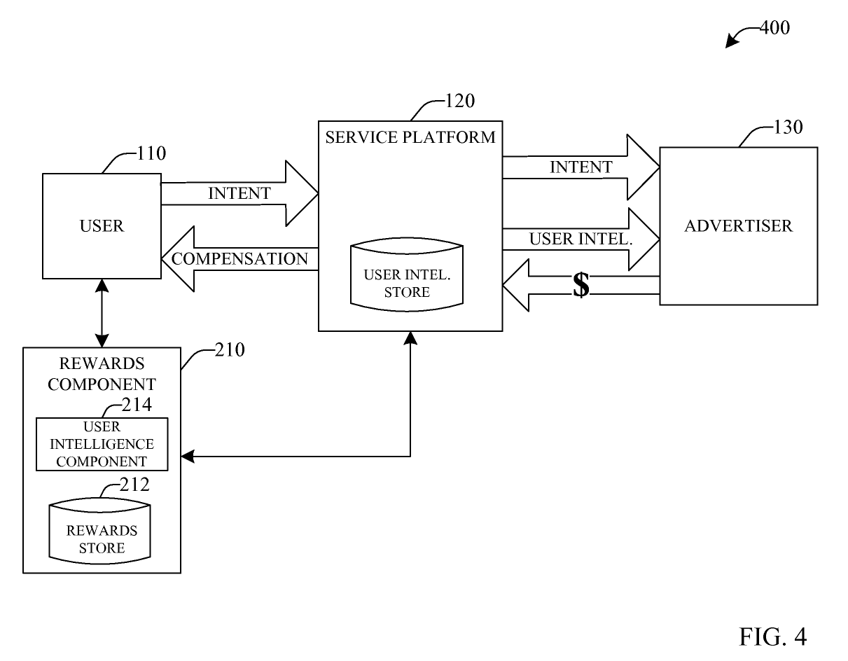

FIG. 4 depicts a computer system 400 that gathers intelligence on a user 110 and stores it in a service platform 120. The user intelligence can be collected as described above. Then, the intelligence is stored in the service platform. Storing the user intelligence serves at least two purposes: (i) establishing a profile of the users that interact with the service platform. Such a profile provides valuable information to the service platform for targeting advertisement campaigns online and off the network. Alternatively or in addition, the user profile derived from the user intelligence can be employed by the service platform to offer additional services or content to the user, as discussed below: (ii) selling the intelligence to an advertiser 130 (FIG. 4). Advertisers benefit by having access to the user intelligence similarly to the manner in which the service platform does.

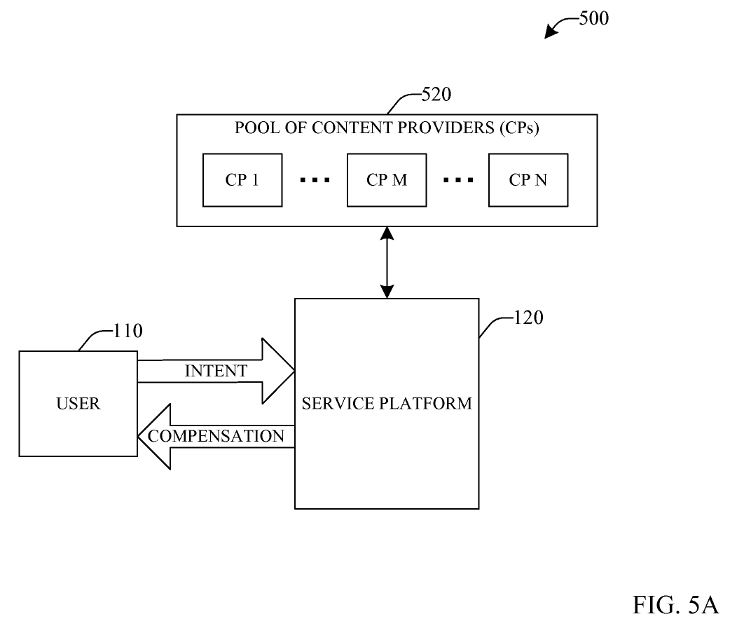

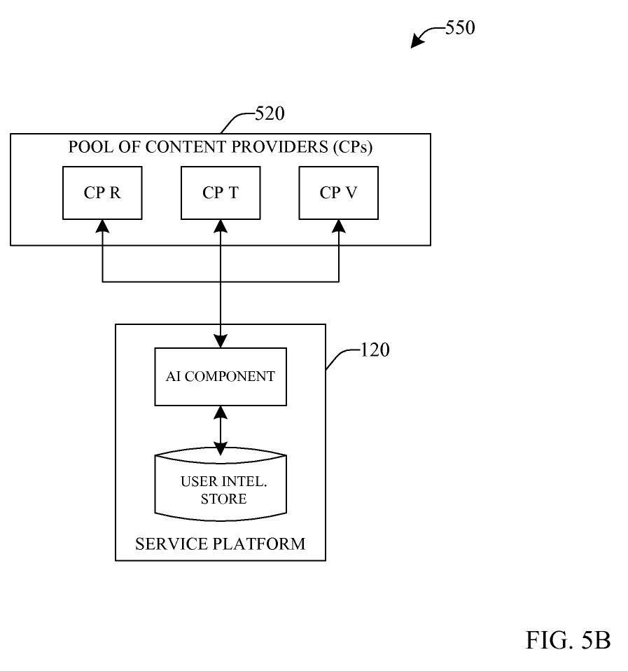

FIG. 5A illustrates a system in which the service platform partners with, or acquires, a pool of third-party premium content providers 520 (CP 1, . . . , CP M, . . . , and CP N). FIG. 5B illustrates a system variation where an artificial intelligence component selects one or more third-party providers (e.g. CP R, CP T, and CP V) from the pool of content providers, based on user intelligence (historical and behavioral data) available in the user intelligence store. Examples of third party providers are online schools and libraries; airlines; rental car services; premium entertainment services; commodity service providers such as cable, phone, and voice-over-IP; and social networking services.

Customization via the artificial intelligence component 250 is not limited to existing CPs in the pool of providers 520: When a desired CP is absent, the AI component 250 can alert the service platform of a desirable partnership, summarize the characteristic of a third-party content provider, and initiate the partnership process. As an example, the AI component can identify a tech savvy user with gross income higher than a threshold value such that the user is not eligible for a free filing option with the Internal Revenue Service (IRS). To retain such users and to promote the service platform among a specific segment, a partnership with a tax-filing service provider can be desirable. Users that benefit with such partnership may be charged for the filing costs in case they stop using the service platform within a determined period of time. In another example, the AI component 250 can infer who the users sensitive to the risk of identity theft are, and thus suggest a partnership with credit bureaus to promote the service platform and satisfy the need of such users. In such partnership, the user would register with the consumer bureau, which will send an alert to the user via the service platform whenever a significant change in the credit report of the user takes place. The alert would contain indicative pointers about the change, alerting only whether the change was positive, negative or logistical. Users can then use points to access a full copy of their credit report.

In another aspect, as part of the alert and for further analysis, the AI component 250 can present to the service platform a summary of the user intelligence employed to determine that a CP is desirable. It should be appreciated that the artificial intelligence component is not limited to residing in the platform service (FIG. 5B); for example, it could be AI component 250 (FIG. 2). Such a partnership and customization can (i) further distinguish the service provider in its user price incentive, (ii) enhance the user experience through an increased variety of incentives with the ensuing user retention, and (iii) promote access to the service platform from a specific user segment.

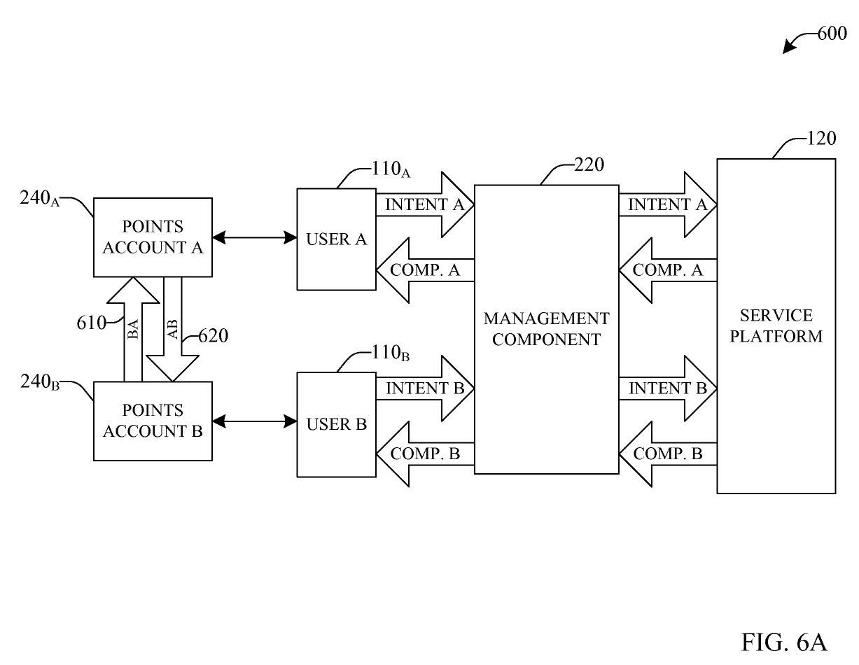

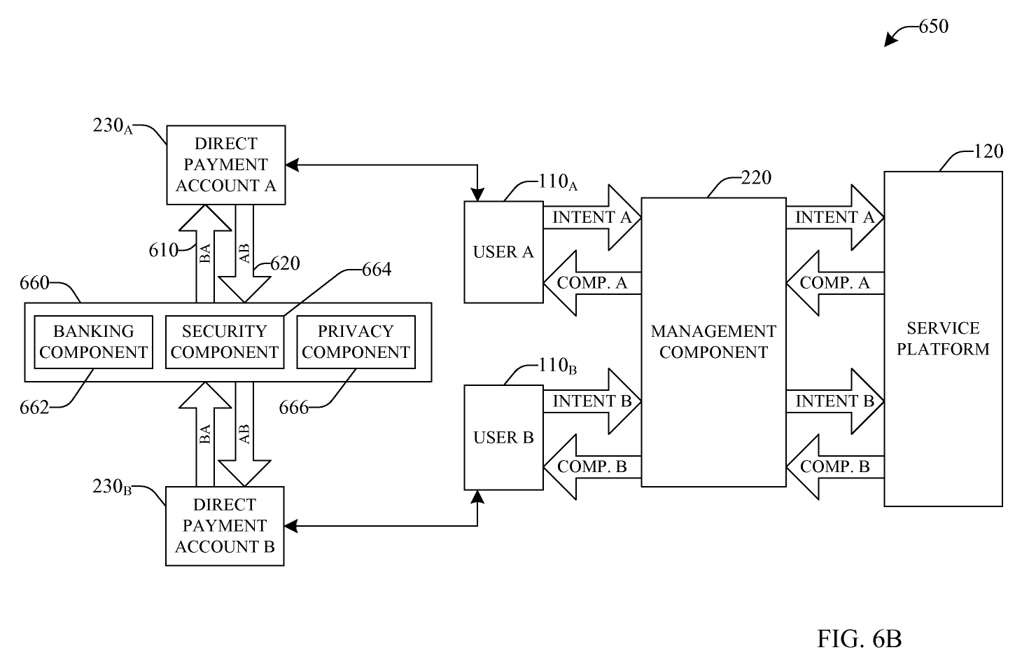

FIG. 6A and 6B show, respectively, computer systems to exchange compensation points and direct-payment compensation among users. Transferring points and direct payments from one user to another is also contemplated in this system. Points are exchanged or transferred instead of rewards to prevent problems with copyrighted materials or other form of protected intellectual property, such as licensed software. In an embodiment, system 600 (FIG. 6A), a management component 220 checks whether user A and user B meet eligibility requirements to exchange points. Eligible users are those users that access the service platform from an eligible machine and are closely related (e.g., family and friends). Once such requirement is met, there is no restriction on the points nature (generic or specific) or number to be exchanged other that the point balances of user A and user B be sufficient for the exchange to take place; neither user A nor user B can carry a negative balance. In an alternative scenario, user A or user B can incur an overdraft of their point accounts (240_{A} and 240_{B}) to a predetermined extent based on historical and behavioral data.

At the time of the transaction, the AI component 250 could assess creditworthiness of users A and B and determine whether a negative point balance is allowed or not. Once the exchange 610 from user B to A and 620 from user A to B is completed the management component 220 updates the users' point accounts. In another embodiment, to transfer monies in the direct payment accounts between user A and a user B, a computer system 650 (FIG. 6B) comprises an intermediary platform 660 and the management component 220. The management component verifies users are eligible and legitimate for the direct payment exchange to take place. In this embodiment, the functionalities of the components in the intermediary platform responsible for the actual transfer are the following.

A banking component 662 executes transfer between direct payment accounts once the balance in such accounts is compatible with the requested transaction. In case the balances are inadequate and depending on the user, the banking component can credit the direct payment accounts with the necessary funds for the transaction to take place. A transaction security component 664 ensures that the transaction among the user is not compromised by a malicious third party, and a privacy component 666 maintains prevents sensitive information (e.g., account balance, details of past transactions, etc.) Component(s) of the intermediary platform can be provided by a third-party service platform or an affiliate CP or a combination thereof. While operation of systems 600 and 650 is described with two users, it should be appreciated that such systems allow, respectively, point and direct payment transactions (transfer and exchange) among a plurality of users.

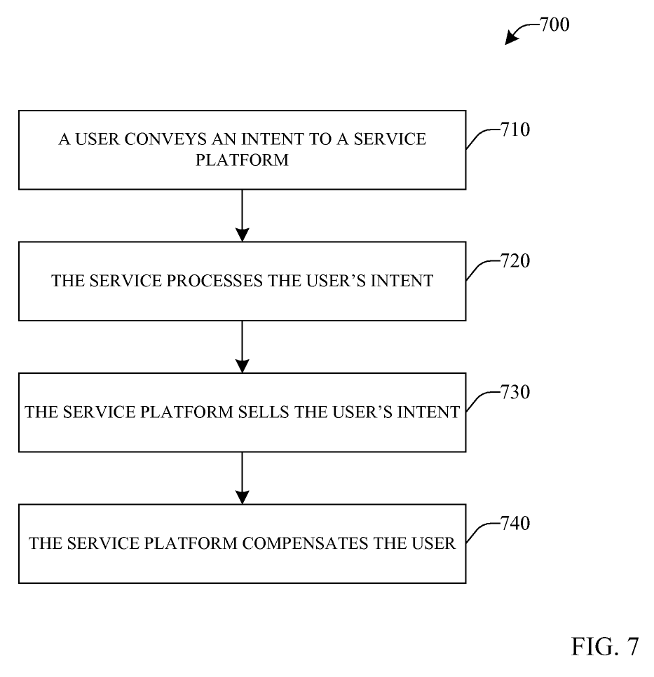

FIGS. 7-12 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers.

FIG. 7 presents a computer-implemented method 700 that facilitates compensation of a user of a service platform in return for the user's intent. At 710 a user conveys intent to a service platform. The intent constitutes the key to receive a specific service from the service platform. Thus, the user discloses intent based on need and the expectation that the provided service would be relevant. At 720 the service platform processes the user's intent, providing a service according to the user's intent. At 730, the service platform sells the user's intent. In one embodiment, the intelligence is sold to an advertiser (130, FIG. 4). To the advertiser, knowledge of the user's intent facilitates targeting of advertisement products, which can result in an increased return-on-investment when buying ad space from the service platform. Thus, user's intent has an intrinsic monetary value to the advertiser.

In another embodiment, the user intelligence can be sold to a direct mail, offline service enterprise. Such enterprise can also use the intelligence information for a targeted solicitation campaign. Yet in another aspect, the service platform can sell the user intelligence to third-party content providers, or exchange for specific content. The service platform recognizes the monetary value associated with the user's intent by compensating the user at 740.

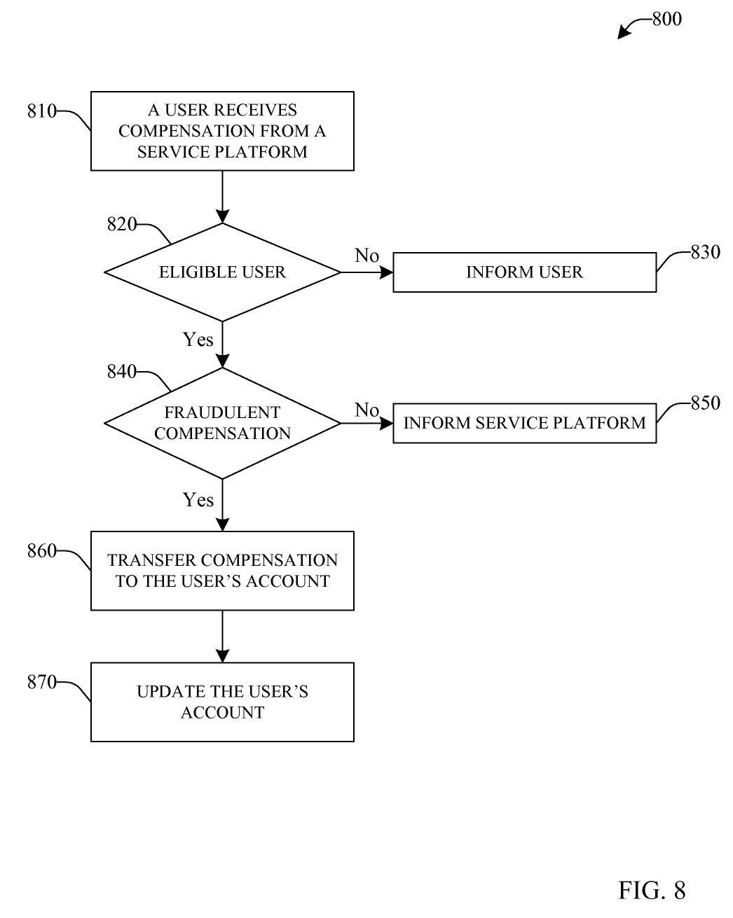

FIG. 8 presents a computer-implemented method to manage a user's compensation. At 810 the user receives compensation from a service platform. Compensation can be a direct payment or a redeemable compensation point, and it is awarded in proportion to usage of the service platform, and economic value of the user to the service platform. Acts 820 and 840 are validation acts that check, respectively, the eligibility and legitimacy of the user to receive the compensation. It should be appreciated that an eligible user, e.g., a user with a system that is compliant with the terms of the intent-compensation proposition of the service platform, can still attempt to obtain fraudulent compensation by misrepresenting intent. For example, a user can submit intent using a software script using an eligible configuration. In case the user is not eligible for compensation the user is so informed at 830. In case fraudulent activity is detected, the service platform is informed at 850. Informing the service platform has the objective of investigating or penalizing the user. Successful eligibility and legitimacy checks lead to 860, in which the user's compensation is transferred to the user's compensation accounts; points account or direct payments account or a combination thereof. At 870 the account balance is updated.

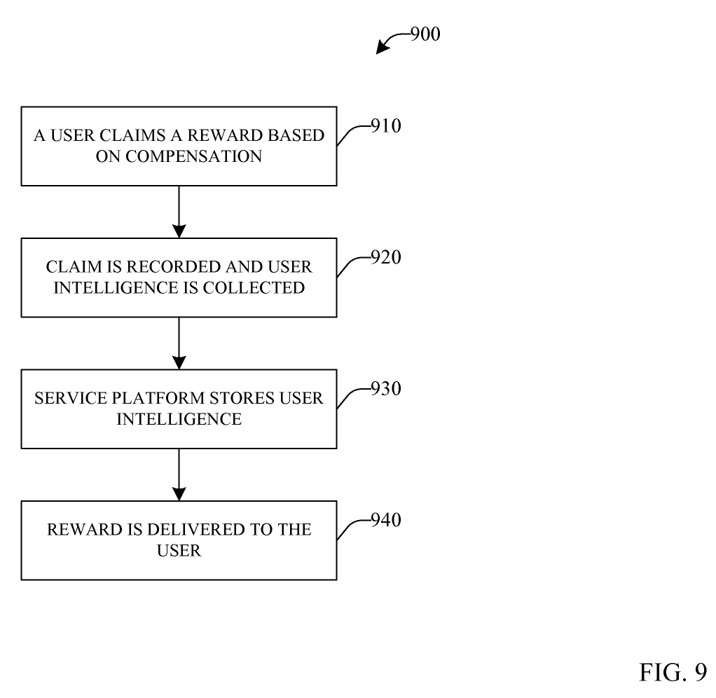

FIG. 9 presents a computer-implemented method 900 for a user to claim rewards based on the user's existing compensation. At 910 a user claims a reward. The claimed reward is compatible with the user's accumulated compensation. In an alternative scenario, depending on the status of the user with, or economic value to, the service platform (e.g., loyal customer, affluent user), a deficit of points that may result from claiming a specific reward can be compensated by the rewards component (210, FIG. 2) or the service platform.(120, FIG. 1). In another alternative scenario, the reward component can accept the user request of a transfer from another user in an attempt to compensate a point deficit (see below, method 1200).

The reward claim is recorded and user intelligence is collected at 920. In an aspect of the claimed subject matter, the user intelligence may also comprise a feedback summary regarding the user experience using the service platform. Such feedback can refer to the quality of the rewards, the service platform, or affiliated content providers. At 940 the reward is transferred to the user. In one aspect of the claimed subject matter, the transfer comprises (i) downloading digital goods such as songs, movies, pictures, software, legal and technical documents, eBooks, etc.; (ii) downloading a passkey for buying goods online at selected retailers that may be part of a pool of CPs that a service platform has partnered with or acquired (520, FIG. 5A); (iii) or accessing online premium content.

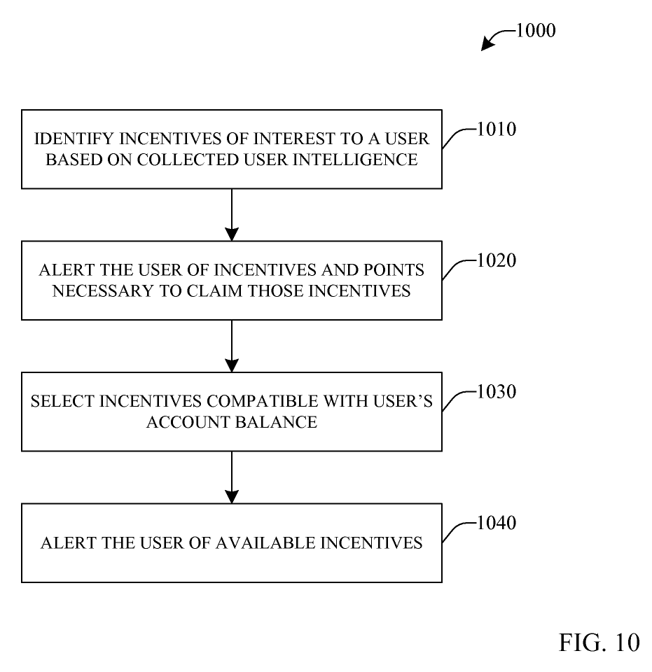

FIG. 10 presents a computer-implemented method 1000 to alert a user of incentives of interest or available. Act 1010 is based on intelligence collected on the user and consists of identifying rewards that can be of interest to the user, or that the user qualifies for based on the balance in the user's point account. In one embodiment, such act could be facilitated by an artificial intelligence component, which infers the kind of incentives that may be of interest to the user. At 1020 the user is alerted of incentives of possible interest and the points necessary to claim those incentives. In one aspect, in case the user does not have the necessary point balance to claim the suggested incentive but desires to claim it, the user can request a point transfer from another user or can buy those points using monies in a direct payment account (230, FIG. 2). Act 1030 and act 1040 select incentives that are compatible with the user's point balance and alert the user of those available incentives, respectively.

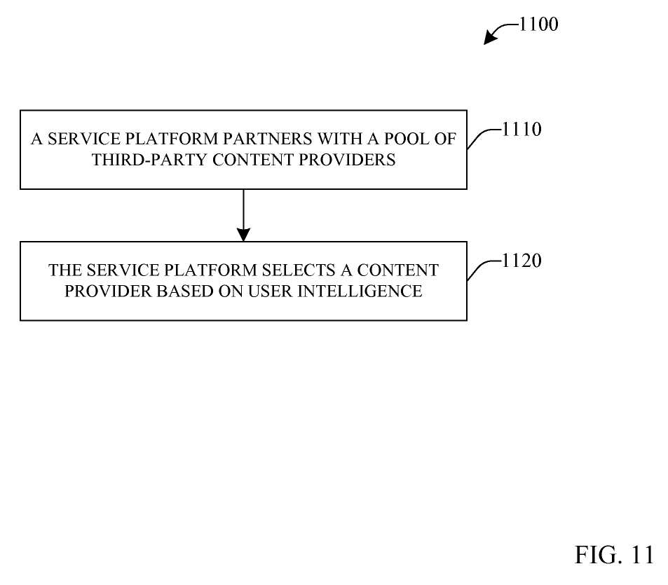

FIG. 11 presents a computer-implemented method 1100 to enhance user experience and promote user retention that is based on partnering with, or acquiring, third-party content providers. At act 1110 the service platform establishes a partnership with, or acquires, a pool of third-party content providers. In one aspect, these content providers can be (a) suggested by an artificial intelligence component when implementing method 1000 (FIG. 10), or (b) selected to enrich the incentives offered to the user in return of the user's intent, enhancing the user experience. At 1120 the service platform selects at least one content provider from the pool of content providers based on user intelligence. Such an act customizes the user experience and thus promotes user retention. Additionally, the customization makes the service provider an instrument for the user to access specific rewards while obtaining an intended service.

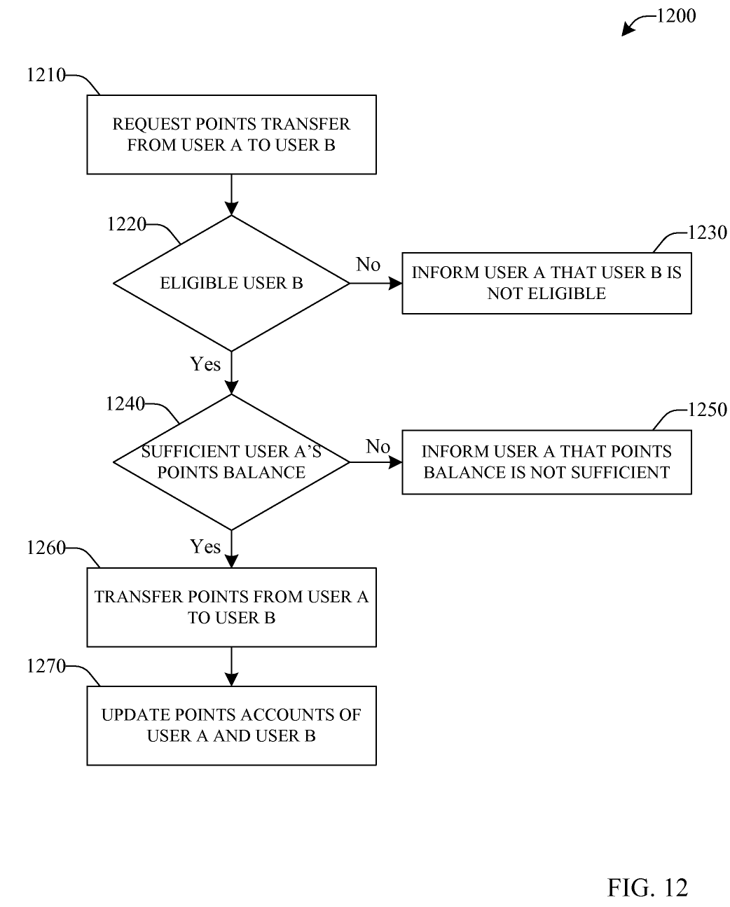

FIG. 12 presents a computer-implemented method 1200 to transfer compensation points among users. The method is illustrated with two users, but it should be appreciated that the method also applies to more than two users. At 1210 a sender user (e.g., A) requests a point transfer to a recipient user (e.g., B). Such a request can be in the context of methods 900 and 1000 presented above. Once the request is placed, the eligibility of the recipient user is checked at 1220, and if the user is not eligible the sender user is duly informed at 1230. At 1240 the points account balance of sender user is checked to confirm that sufficient points are available for the transfer transaction. Should the balance be insufficient, the sender user is notified at 1250. In one aspect of the claimed subject matter, the said sender user requests a point transfer from another user.

In another aspect, based on user intelligence, the sender user can be granted the necessary points to complete the transaction by the service platform. Once eligibility and availability of points is verified, the points are transferred at 1260, and the accounts of sender user and recipient user are updated. The method is not limited to transfer but it also comprises exchange of points among users. It should be appreciated that method 1200 is not limited to point transfers but it can also be applied to exchange of points. Exchange can be advantageous among users that have collected specific points (see above), whose types complement the users' interests.

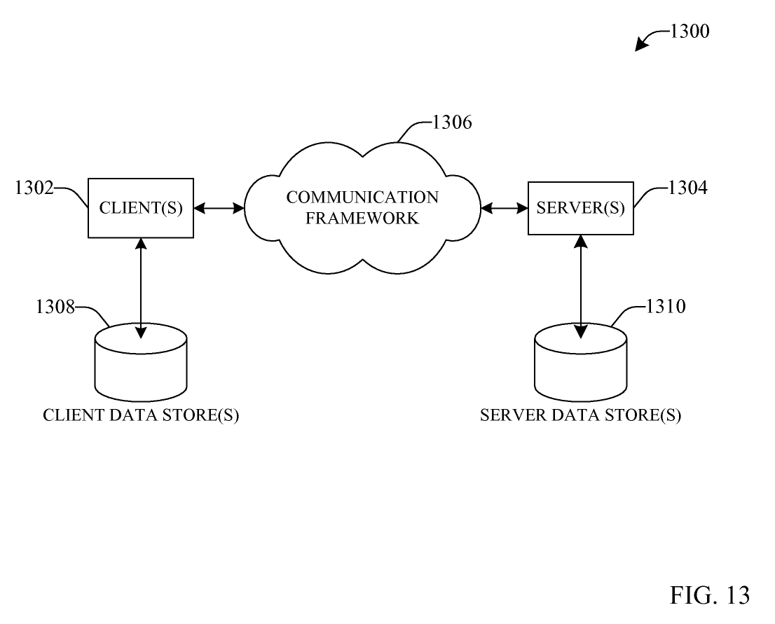

FIG. 13 illustrates a schematic block diagram of a computing environment 1300 in accordance with the subject specification. The system 1300 includes one or more client(s) 1302. The client(s) 1302 can be hardware and/or software (e.g., threads, processes, computing devices). The client(s) 1302 can house cookie(s) and/or associated contextual information by employing the specification, for example.

The system 1300 also includes one or more server(s) 1304. The server(s) 1304 can also be hardware and/or software (e.g., threads, processes, computing devices). The servers 1304 can house threads to perform transformations by employing the specification, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

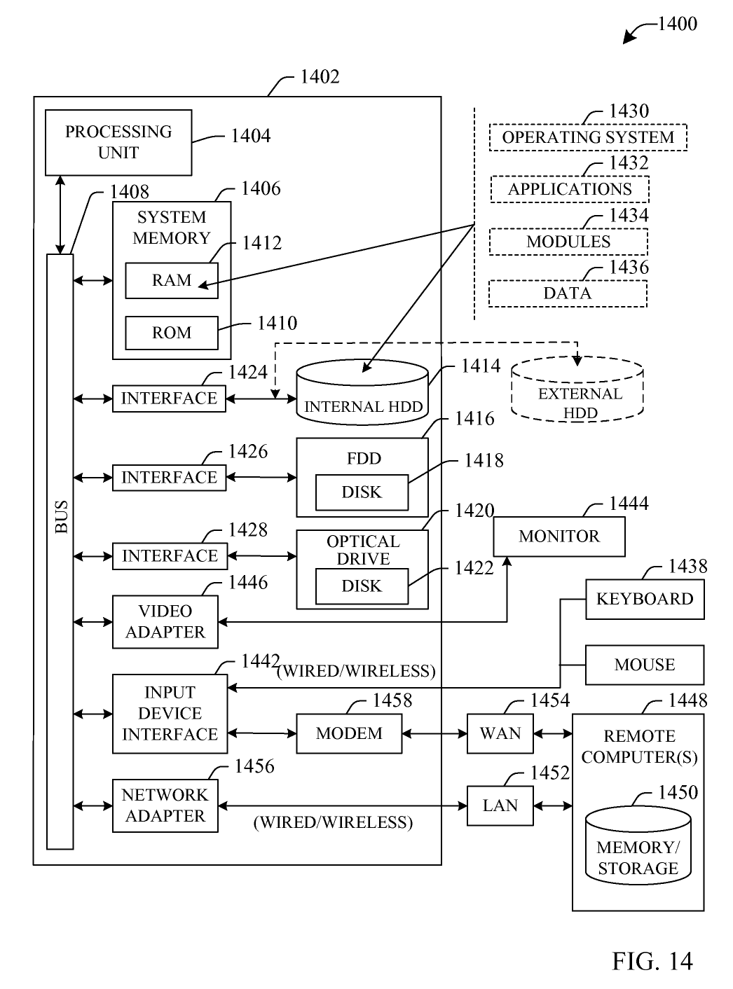

FIG. 14 illustrates a block diagram of a computer operable to execute the disclosed architecture. In order to provide additional context for various aspects of the subject specification, FIG. 14 and the following discussion are intended to provide a brief, general description of a suitable computing environment 1400 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

In FIG. 14, the example environment 1400 for implementing various aspects of the specification includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures may also be employed as the processing unit 1404.

The system bus 1408 can be any of several types of bus structure that may further interconnect to a memory bus (with or without a memory controller), a peripheral bus, and a local bus using any of a variety of commercially available bus architectures. The system memory 1406 includes read-only memory (ROM) 1410 and random access memory (RAM) 1412. A basic input/output system (BIOS) is stored in a non-volatile memory 1410 such as ROM, EPROM, EEPROM, which BIOS contains the basic routines that help to transfer information between elements within the computer 1402, such as during start-up. The RAM 1412 can also include a high-speed RAM such as static RAM for caching data.

The computer 1402 further includes an internal hard disk drive (HDD) 1414 (e.g., EIDE, SATA), which internal hard disk drive 1414 may also be configured for external use in a suitable chassis (not shown), a magnetic floppy disk drive (FDD) 1416, (e.g., to read from or write to a removable diskette 1418) and an optical disk drive 1420, (e.g., reading a CD-ROM disk 1422 or, to read from or write to other high capacity optical media such as the DVD). The hard disk drive 1414, magnetic disk drive 1416 and optical disk drive 1420 can be connected to the system bus 1408 by a hard disk drive interface 1424, a magnetic disk drive interface 1426 and an optical drive interface 1428, respectively. The interface 1424 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. It is appreciated that the specification can be implemented with various commercially available operating systems or combinations of operating systems.

A user can enter commands and information into the computer 1402 through one or more wired/wireless input devices, e.g., a keyboard 1438 and a pointing device, such as a mouse 1440. Other input devices (not shown) may include a microphone, an IR remote control, a joystick, a game pad, a stylus pen, touch screen, or the like. These and other input devices are often connected to the processing unit 1404 through an input device interface 1442 that is coupled to the system bus 1408, but can be connected by other interfaces, such as a parallel port, an IEEE 1394 serial port, a game port, a USB port, an IR interface, etc.

A monitor 1444 or other type of display device is also connected to the system bus 1408 via an interface, such as a video adapter 1446. In addition to the monitor 1444, a computer typically includes other peripheral output devices (not shown), such as speakers, printers, etc.

The computer 1402 may operate in a networked environment using logical connections via wired and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wired/wireless connectivity to a local area network (LAN) 1452 and/or larger networks, e.g., a wide area network (WAN) 1454. Such LAN and WAN networking environments are commonplace in offices and companies, and facilitate enterprise-wide computer networks, such as intranets, all of which may connect to a global communications network, e.g., the Internet.

When used in a LAN networking environment, the computer 1402 is connected to the local network 1452 through a wired and/or wireless communication network interface or adapter 1456. The adapter 1456 may facilitate wired or wireless communication to the LAN 1452, which may also include a wireless access point disposed thereon for communicating with the wireless adapter 1456.

When used in a WAN networking environment, the computer 1402 can include a modem 1458, or is connected to a communications server on the WAN 1454, or has other means for establishing communications over the WAN 454, such as by way of the Internet. The modem 1458, which can be internal or external and a wired or wireless device, is connected to the system bus 1408 via the serial port interface 1442. In a networked environment, program modules depicted relative to the computer 1402, or portions thereof, can be stored in the remote memory/storage device 1450. It will be appreciated that the network connections shown are example and other means of establishing a communications link between the computers can be used.

The computer 1402 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim

What is claimed is:

1. A computer system that compensates a user of a service platform in return for knowledge of user intent, comprising
a management component that receives information regarding user intent via Internet or wireless communications, the management component sharing a subset of the user intent information with a service platform; and
a rewards component that processes and allocates rewards to a user as a function the subset of user intent shared with the service platform.

2. The system of claim 1, the rewards component allocating reward points or direct payments allocated in compensation accounts.

3. The system of claim 2, the reward points being perishable or perennial, with perishable points good to claim a reward for a determined period of time, and perennial points good to claim a reward at all times.

4. The system of claim 1 further comprising an eligibility component that verifies that the user is eligible for rewards.

5. The system of claim 1 further comprising an antifraud component that legitimizes a user's rewards.

6. The system of claim 1 further comprising a user intelligence component that collects intelligence on the user when claiming a reward.

7. The system of claim 1, the service platform partners or acquires a content provider to promote user retention.

8. The system of claim 7 further comprising an artificial intelligence component that infers desirable content providers based on intelligence collected on the user.

9. The system of claim 1, the management component facilitates compensation exchange among a plurality of users.

10. A computer-implemented method that facilitates compensating a user of a service platform in return for the user's intent, comprising conveying user's intent to the service platform;
processing the user's intent and delivering a service; and
compensating the user of the service platform with reward points or a direct payment.

11. The method of claim 10, further comprising
claiming rewards based on user's compensation; and
collecting intelligence on the user when claiming rewards.

12. The method of claim 10, further comprising accessing a rewards store.

13. The method of claim 10, further comprising alerting a user of available rewards based on the user's compensation and incentives on a rewards store.

14. The method of claim 10, further comprising inferring rewards of interest to the user based on intelligence collected on the user.

15. The method of claim 10, further comprising exchanging compensation among a plurality of users.

16. A computer implemented system that facilitates commercial transactions, comprising a management component that receives information regarding user intent, the management component brokers the user intent information to a plurality of service providers, and selects at least one of the service providers to expose to the user as a function of determined or inferred capability to satisfy user needs, and rewards offered to the user in exchange for the user intent information.

17. The system of claim 16, further comprising a rewards component that allocates the rewards to the user.

18. The system of claim 16, comprising an eligibility component that verifies that the user is eligible for rewards.

19. The system of claim 16, the management component pairs users with prospective service providers as a function of user profile.

20. The system of claim 16, the management component pairs users with prospective service providers as a function of likelihood of a user engaging in a commercial transaction.
